(19) United States
(12) Patent Application Publication
(10) Pub. No.: US 2008/0023094 A1
(43) Pub. Date: Jan. 31, 2008

(54) LOW-PERMEABILITY RESIN HOSE

(75) Inventor: Kensuke SASAI, Komaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKAI RUBBER INDUSTRIES, LTD., Komaki-shi (JP)

(21) Appl. No.: 11/828,573

(22) Filed: Jul. 26, 2007

(30) Foreign Application Priority Data
Jul. 31, 2006 (JP) 2006-208299

(51) Int. Cl. F16L 11/04; B32B 1/08

(52) U.S. Cl. 138/137; 138/141

(57) ABSTRACT

A low-permeability resin hose which is less permeable to automotive fuel or refrigerant, and excellent in interlaminar adhesion and flexibility. The low-permeability resin hose comprises a tubular low-permeability layer formed by using the following component (A); and an outer layer formed by using the following component (B) on an outer peripheral surface of the low-permeability layer:

(A) an alloy material wherein an island phase (domain) comprising modified high-density polyethylene resin is dispersed in a sea phase (matrix) comprising an ethylene-vinyl alcohol copolymer;
(B) polyamide resin having a high amino value.

### BACKGROUND OF THE INVENTION

1. Field of the Invention

The present invention relates to a low-permeability resin hose, specifically, a low-permeability resin hose excellent in permeation resistance to fuels such as gasoline, alcohol-containing gasoline (gasohol), alcohol, hydrogen, light oil, dimethyl ether, diesel oil, compressed natural gas (CNG) and liquefied petroleum gas (LPG), or to refrigerants such as chlorofluorocarbon, chlorofluorocarbon's (CFC's) substitute, water and carbon dioxide.

2. Description of the Art

Regulations against vapor emission of hydrocarbon from automotive fuel hoses have been tightened with globally increased environmental awareness. Especially, considerably stringent regulations have been legislated in the United States of America. Under such circumstances, to cope with more stringent regulations against vapor emission of hydrocarbon, multi-layer structured hoses provided with a low-fuel-permeability layer made of fluororesin have been proposed.

The fluororesin layer is relatively excellent in low-fuel-permeability. However, the thickness of the fluororesin layer must be increased to cope with recent regulations against vapor emission, which results in the problem that material cost is expensive.

Then, an ethylene-vinyl alcohol copolymer (EVOH) has been focused upon as more excellent low-fuel-permeability resin than fluororesin. A hose provided with the EVOH layer enables sufficient low-fuel-permeability even if the thickness of the EVOH layer is relatively thin, which results in an advantage in terms of material cost.

As such hoses provided with the low-permeability layer made of EVOH, the following hoses (1) to (3) have been proposed.

(1) A multi-layer fuel tube obtained by forming an outer layer of modified high-density polyethylene (modified HDPE) on an outer peripheral surface of an inner EVOE layer (see, Japanese Unexamined Patent Publication No. 2003-191396).

(2) A multi-layer fuel tube obtained by forming an outer layer of an alloy material comprising high-density polyethylene (HDPE), ethylene-α-olefin and dicarboxylic-acid-modified polyolefin (such as maleic-anhydride-modified polypropylene) on an outer peripheral surface of an inner EVOH layer (see, Japanese Unexamined Patent Publication No. 2003-194263).

(3) A multi-layer fuel tube obtained by forming each modified HDPE layer on an inner peripheral surface and an outer peripheral surface of an inner EVOH layer (see, Japanese Unexamined Patent Publication No. 2004-122459).

However, EVOH has flexural modulus of approximate 4000 MPa and is extremely rigid, and thus lacks in flexibility. Therefore, hoses disclosed in the above publications may cause cracking in the EVOH layer in bending process, or may easily cause solvent cracking in soaking in fuel after a connector is pressed into the hose, which may deteriorate low-fuel-permeability. Especially, when an inner layer of the hose is made of EVOH, since EVOH has a water-absorbing property, properties such as rigidity and low-permeability may deteriorate due to water absorption caused thereby.

Further, when a modified HDPE layer is formed as an outer layer, as the above-mentioned hoses, the outer layer may deteriorate by ultraviolet radiation. On the other hand, since there is a big difference in melting point between polyolefin (such as modified HDPE) and EVOH, the polyolefin layer may fall off (generally speaking, “slip”) in bending process with heat. For this reason, layer formation with secure interlaminar adhesion is required even in such a case.

In view of the foregoing, it is an object of the present invention to provide a low-permeability resin hose which is less permeable to automotive fuel or refrigerant, and excellent in interlaminar adhesion and flexibility.

### SUMMARY OF THE INVENTION

To achieve the aforesaid object, a low-permeability resin hose according to a first aspect of the present invention comprises a tubular low-permeability layer formed by using the following component (A); and an outer layer formed by using the following component (B) on an outer peripheral surface of the low-permeability layer:

### (A) an alloy material wherein an island phase (domain) comprising modified high-density polyethylene resin is dispersed in a sea phase (matrix) comprising an ethylene-vinyl alcohol copolymer;

### (B) polyamide resin having a high amino value.

Further, a low-permeability resin hose according to a second aspect of the present invention comprises a tubular low-permeability layer formed by using the following component (A); a bonding layer formed by using the following component (C) on an outer peripheral surface of the low-permeability layer; and an outer layer formed by using the following component (D) on an outer peripheral surface of the bonding layer:

### (A) an alloy material wherein an island phase (domain) comprising modified high-density polyethylene resin is dispersed in a sea phase (matrix) comprising an ethylene-vinyl alcohol copolymer;

### (C) modified high-density polyethylene resin;

### (D) polyamide resin having a low amino value.

The inventor of the present invention has conducted intensive studies to obtain a low-permeability resin hose which is less permeable to automotive fuel or refrigerant, and excellent in interlaminar adhesion and flexibility. As a result, the inventor has found that when the low-permeability layer is formed by using an alloy material wherein an island phase (domain) comprising modified high-density polyethylene resin is dispersed in a sea phase (matrix) comprising an ethylene-vinyl alcohol copolymer (EVOH), the resultant layer is excellent in low-permeability and flexibility, differently from the case where only ethylene-vinyl alcohol copolymer (EVOH) is used and the resultant layer is highly elastic, and thus problems such as solvent cracking are solved. He also found out that the problem of ultraviolet ray degradation can be solved by forming an outer layer made of polyamide resin on an outer peripheral surface of such low-permeability layer. Further, he found when a material for forming an outer layer is polyamide resin having a high amino value (amino terminal group concentration of not less than 40μ equivalent weight/g), interlaminar adhesion is improved and thus problems such as “slip” in bending process with heat can be solved. Thus, the present invention has been attained.

In the meantime, when the outer layer is made of polyamide resin having a low amino value, the desired interlaminar adhesion obtained as in the above-mentioned hose cannot be obtained. However, he found that when a bonding layer is formed by using modified high-density polyethylene resin between the low-permeability layer and the outer layer, such a problem can be solved, and thus excellent effect as same as in the above-mentioned hose can be obtained.

As mentioned above, since the low-permeability resin hose of the present invention is provided with the low-permeability layer formed by using the alloy material wherein an island phase comprising modified high-density polyethylene resin is dispersed in a sea phase comprising an ethylene-vinyl alcohol copolymer, problems such as solvent cracking may not occur, low-permeability to fuel or refrigerant is improved, flexibility is excellent, interlaminar adhesion is good with the outer layer made of polyamide resin having a high amino value formed on the outer peripheral surface of the low-permeability layer, which enables to maintain adhesive force at not less than 20 N/cm (target value). Therefore, problems such as “slip” of the outer layer in bending process with heat can be solved, and thus resistance to ultraviolet ray becomes excellent.

Further, when a bonding layer is formed by using modified high-density polyethylene resin between the outer layer and the low-permeability layer, even if the outer layer is made of polyamide resin having a low amino value, the problem of interlaminar adhesion can be solved, and thus excellent effect as same as in the above-mentioned low-permeability resin hose can be obtained.

Still further, when an inner layer is formed by using an alloy material wherein an island phase comprising an ethylene-vinyl alcohol copolymer is dispersed in a sea phase comprising modified high-density polyethylene resin, or modified high-density polyethylene resin on an inner peripheral surface of the low-permeability layer, degradation of physical properties due to water absorption in the low-permeability layer can be prevented and the inner layer can be thermally bonded to a connector, and thereby leakage of fuel or the like can be further prevented on a joint with the connector.

### BRIEF DESCRIPTION OF THE DRAWING

FIG. 1 is a diagram illustrating an embodiment of a low-permeability resin hose according to the present invention;

FIG. 2 is a diagram illustrating another embodiment of a low-permeability resin hose according to the present invention; and

FIG. 3 is a diagram illustrating a still another embodiment of a low-permeability resin hose according to the present invention.

### DESCRIPTION OF THE PREFERRED EMBODIMENTS

Embodiments of the present invention will hereinafter be described in detail.

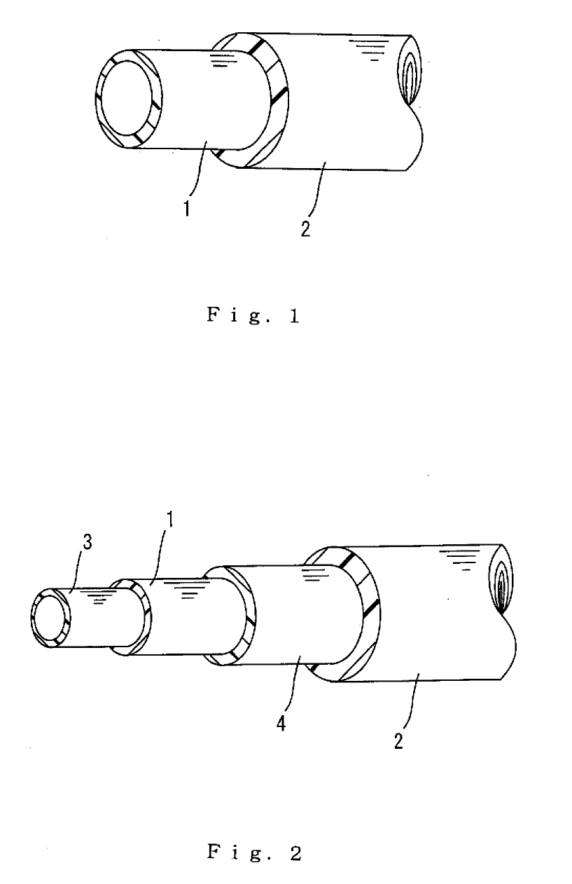

A low-permeability resin hose according to the present invention includes a tubular low-permeability layer 1 and an outer layer 2 provided on an outer peripheral surface of the low-permeability layer 1, as shown in FIG. 1, in which the low-permeability layer 1 is formed by using the following component (A) and the outer layer 2 is formed by using the following component (B).

### (A) an alloy material wherein an island phase (domain) comprising modified high-density polyethylene resin is dispersed in a sea phase (matrix) comprising an ethylene-vinyl alcohol copolymer;

### (B) polyamide resin having a high amino value.

As a material for forming the low-permeability layer 1 (low-permeability layer material), the alloy material, as mentioned as the above (A), is used, that is the alloy material in which an island phase (domain) comprising modified high-density polyethylene resin (modified HDPE) is dispersed in a sea phase (matrix) comprising an ethylene-vinyl alcohol copolymer (EVOH). The high-density polyethylene resin (HDPE) herein means that the polyethylene resin has specific gravity of 0.93 to 0.97, preferably 0.93 to 0.96 and a melting point of 120° C. to 145° C. The specific gravity is a value in accordance with ISO 1183 and the melting point is a value in accordance with ISO 3146. Examples of the modified HDPE include those which are modified so as to have one or more than one of functional groups including a maleic anhydride group, a maleic acid group, an acrylic acid group, a methacrylic acid group, an acrylate ester group, a methacrylate ester group, a vinyl acetate group and an amino group. The modification ratio of such modified HDPE is preferably 0.1 to 5% by weight.

The alloy material (component (A)) can be obtained by melt-kneading the EVOH and the modified HDPE at a specific ratio (wherein the temperature for such melt-kneading is preferably room temperature (22° C.) to 280° C., more preferably 40 to 260° C.). In the alloy material, the EVOH becomes a sea phase, which ensures a low permeability against gasoline fuel or refrigerant gas, while the modified HOPE becomes an island phase, which improves low impact resistance and the like as weak points in the case where the EVOH is solely used.

The mixing ratio by volume of the EVOH and the modified HOPE in the alloy material (component (A)) is preferably EVOH/modified HDPE=25/75 to 90/10, more preferably, EVOH/modified HDPE=30/70 to 80/20. When the mixing ratio by volume of the EVOH is over 90% (or the mixing ratio by volume of the modified HOPE is less than 10%), flexural modulus increases. When the mixing ratio by volume of the EVOH is less than 25% (or the mixing ratio by volume of the modified HDPE is over 75%) an island-sea structure is reversed, resulting in inferior low-permeability. The island-sea ratio (by volume) in the low-permeability layer 1 approximately corresponds to the ratio by volume of the EVOH and the modified HDPE of the alloy material.

The island-sea structure as mentioned above can be identified by dyeing an exposed cross-sectional surface of the low-permeability layer 1 with iodine (for example, for about 1 hour at room temperature), cutting a piece (about 0.5 mm square) out, and observing thereof by means of a scanning electron microscopy (SEM). Since the phase comprising the EVOH is dyed with iodine, such a dyed portion looks whitish with electron irradiation. In the meantime, since the phase comprising the modified HDPE is not dyed with iodine, such un-dyed portion looks blackish. The island-sea structure can be observed by such color differences.

Further, a compatibilizer, a flame retardant, an antioxidant and the like may be blended into the material for forming the low-permeability layer 1, as required, in addition to the EVOH and the modified HDPE.

Next, in the low-permeability resin hose, as shown in FIG. 1, the polyamide resin having a high amino value (component (B)) is used for the material for forming the outer layer 2 (outer layer material).

The polyamide resin having a high amino value is preferably those having amino terminal group concentration of not less than 40μ equivalent weight/g, particularly preferably 45 to 100μ equivalent weight/g. When the amino terminal group concentration of the polyamide resin is less than 40μ equivalent weight/g, adhesion with the low-permeability layer 1 tends to deteriorate. When the amino terminal group concentration of the polyamide resin is over 100μ equivalent weight/g, a molecular weight of the polyamide resin decreases, and thus processability tends to deteriorate in terms of melt viscosity in molding, and also physical properties of the molded product tend to deteriorate. Therefore, those having amino terminal group concentration of 45 to 100μ equivalent weight/g are preferred as the polyamide resin having a high amino value.

The amino terminal group concentration of the polyamide resin having a high amino value may, for example, be measured by the following method. A specified amount of polyamide resin is put into a conical flask with a stop cock, and 40 ml of preliminarily prepared solvent (phenol/methanol=9/1 by volume) is added thereto and is agitated by a magnetic stirrer so as to be dissolved. Then, the concentration is obtained by titration with 0.05 N of hydrochloric acid by using thymol blue as an indicator.

The polyamide resin having a high amino value is not particularly limited, as long as its amino value is high. Examples thereof include, for example, polyamide 6 (PA6), polyamide 66 (PA66) polyamide 99 (PA99), polyamide 610 (PA610), polyamide 612 (PA612), polyamide 11 (PA11), polyamide 910 (PA910), polyamide 912 (PA912), polyamide 12 (PA12) and a copolymer of polyamide 6 and polyamide 66 (PA6/66). These may be used alone or in combination of two or more. Among them, PA11 and PA12 are preferably used in terms of adhesion with the low-permeability layer 1, resistance to calcium chloride, and flexibility and the like.

Further, a plasticizer, an antioxidant, a flame retardant, impact modifier and the like may be blended into the material for forming the outer layer 2, as required, in addition to the polyamide resin having a high amino value. Still further, a thermoplastic elastomer may be blended therein to improve flexibility and impact resistance.

As the above-mentioned thermoplastic elastomer, those which have a melting point of not more than 160° C. and rubber elasticity at an ordinary temperature are preferred, such as an ethylene-propylene copolymer and an ethylene-butene copolymer. Among them, those which have a glass transition point of not more than −40° C. are preferred in terms of heat resistance, easy mixing, improvement on impact resistance at a low temperature, and rubber elasticity available at a low temperature. As the thermoplastic elastomer, those which have at least one functional group selected from the group consisting of an epoxy group, an amino group, a hydroxyl group, a carboxyl group, a mercapto group, an isocyanate group, a vinyl group, and their acid anhydride groups, and an ester group, are preferred in terms of improvement on impact resistance. Among them, those which have an epoxy group or a functional group stemmed from a carboxyl group are especially preferred because affinity with the polyamide resin is increased.

The low-permeability resin hose of the present invention, as shown in FIG. 1, is produced, for example, in the following manner. The materials for forming the low-permeability layer 1 and the outer layer 2 are each prepared. Then, these materials are each co-extruded simultaneously by means of melt extruders, and thus, the intended two-layer structured low-permeability resin hose (see FIG. 1) is produced. The low-permeability layer 1 and the outer layer 2 of the above-mentioned hose are laminated for integration at a desired adhesive force (of not less than 20 N/cm) without use of an adhesive agent.

The low-permeability resin hose of the present invention is not limited to a two-layer structured hose, as shown in FIG. 1. For example, a bonding layer 4 may be formed between the low-permeability layer 1 and the outer layer 2 by using an alloy material wherein an island phase comprising EVOH is dispersed in a sea phase comprising modified HDPE, or modified HDPE (see FIG. 2) by which desired interlaminar adhesion can be obtained and degradation of physical properties due to water absorption in the low-permeability layer 1 can be prevented. Further, an inner layer 3 may be formed on an inner peripheral surface of the low-permeability layer 1 to prevent degradation of physical properties due to water absorption in the low-permeability layer 1 (see FIG. 2). The material for forming the inner layer 3 is not particularly limited, however, for example, when the inner layer 3 is formed by using an alloy material wherein an island phase comprising EVOH is dispersed in a sea phase comprising modified HDPE, or modified HDPE, the inner layer 3 can be thermally bonded to a connector, and thereby leakage of fuel or the like can be further prevented on a joint with the connector.

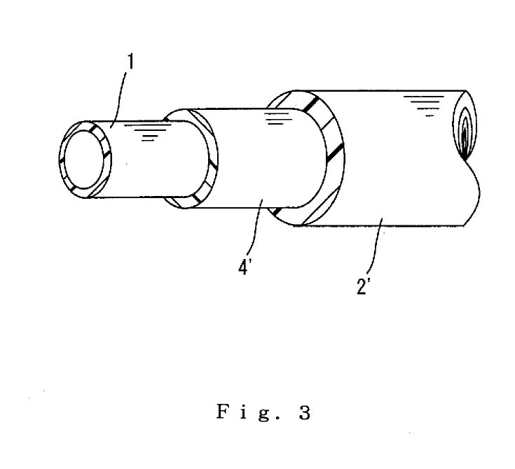

In the meantime, when the outer layer 2 is made of polyamide resin having a low amino value (amino terminal group concentration of less than 40μ equivalent weight/g) instead of the polyamide resin having a high amino value, the desired interlaminar adhesion obtained as in the above-mentioned hose cannot be obtained. However, when a bonding layer 4′ is formed by using modified HDPE between the low-permeability layer 1 and the low-amino-value polyamide resin layer 2′, as shown in FIG. 3, such a problem can be solved, and thus excellent effects as same as in the above-mentioned hose shown in FIG. 1 can be obtained. Further, an inner layer may be formed on an inner peripheral surface of (the low-permeability layer 1) of this hose for the same purpose (see FIG. 2).

The thus obtained low-permeability resin hose of the present invention preferably has an inner diameter of 2 to 40 mm, particularly preferably 2.5 to 36 mm and an outer diameter of preferably 3 to 44 mm, particularly preferably 4 to 40 mm. The low-permeability layer 1 preferably has a thickness of 0.02 to 1.0 mm, particularly preferably 0.05 to 1.0 mm. The outer layer 2 (2′) preferably has a thickness of 0.3 to 3 mm, particularly preferably 0.5 to 2.0 mm. When the inner layer 3 is provided, the inner layer preferably has a thickness of 0.02 to 1.0 mm, particularly preferably 0.05 to 0.5 mm. Further, when the bonding layer 4 (4′) is provided, the bonding layer preferably has a thickness of 0.02 to 2.0 mm, particularly preferably 0.05 to 1.0 mm.

The low-permeability resin hose of the present invention is applicable to a transportation hose of fuels such as gasoline, alcohol-containing gasoline (gasohol), alcohol, hydrogen, light oil, dimethyl ether, diesel oil, compressed natural gas (CNG) and liquefied petroleum gas (LPG), to be used in automotive vehicles as well as other transport machinery including aircraft; vehicles for industrial use such as a forklift, a wheeled tractor shovel, and a crawler crane; and railroad vehicles, or to refrigerants such as chlorofluorocarbon, chlorofluorocarbon's (CFC's) substitute, water and carbon dioxide to be used for air conditioners, radiators or the like.

Next, an explanation will be given to Examples of the present invention and Comparative Examples. It should be understood that the invention be not limited to these examples.

Prior to the explanation of Examples and Comparative Examples, materials herein employed will be explained.

### PA12 (i)

GRILAMID L25ANZ (amino terminal group equivalent weight: 63μ equivalent/g) available from EMS-CHEMIE AG

### PA12 (ii)

UBESTA 3030JLX2 (amino terminal group equivalent weight: 31μ equivalent/g) available from Ube Industries, Ltd.

### EVOH

EVOH (i) and (ii) each having properties (MFR, specific gravity, melting point and ethylene copolymerization rate), as shown in the following table 1, were prepared.

TABLE 1

| | | | | | Specific | Melting | |
|---|---|---|---|---|---|---|---|
| | | | | MFR | gravity | point | Ethylene |
| | | | | ASTM | | | copolymerization |
| | | | Product | D1238 | D1505 | D2117 | rate |
| Type | | Manufacturer | name | g/10 min | g/cm³ | ° C. | mol % |
| EVOH | I | Kuraray | EVAL F | 3.8 | 1.19 | 183 | 32 |
| | | | 101A | | | | |
| | ii | Kuraray | EVAL F | 10 | 1.19 | 183 | 32 |
| | | | 104B | | | | |

### Modified HDPE (i)

Modified HDPE (i) (modification rate: 0.4% by weight, melting point: 135° C., maximum tensile strength: 15 MPa) was prepared by blending maleic anhydride (content: 0.4% by weight) and 2,5-dimethyl-2,5-di(t-butylperoxy)hexane (content: 0.015% by weight) into HDPE (NOVATEC HY430 available from Japan Polyethylene Corporation, specific gravity: 0.956, melting point: 135° C.) and melt kneading the thus obtained blend by means of a twin-screw extruder.

### Modified HDPE (ii)

Modified HDPE (ii) (modification rate: 0.4% by weight, melting point: 132° C., maximum tensile strength: 14 MPa) was prepared by blending maleic anhydride (content: 0.4% by weight) and 2,5-dimethyl-2,5-di(t-butylperoxy)hexane (content: 0.015% by weight) into HDPE (NOVATEC HJ362N available from Japan Polyethylene Corporation, specific gravity: 0.953, melting point: 132° C.) and melt kneading the thus obtained blend by means of a twin-screw extruder.

### (Unmodified) HDPE

HDPE (NOVATEC HB111R available from Japan Polyethylene Corporation, specific gravity: 0.95, melting point: 129° C.)

### Preparation of Alloy Materials

Pellets (alloy materials a to e) were prepared by blending each material at ratios as shown in the following table 2 and kneading the thus obtained blend by means of a twin screw extruder (TEX30α available from JFE Steel Corporation). Dispersibility of each element in the thus obtained alloy material was identified by observing a test piece dyed with iodine by means of a scanning electron microscopy (SEM).

TABLE 2
(parts by volume)

| | | | a | b | c | d | e |
|---|---|---|---|---|---|---|---|
| EVOH | | i | — | — | — | 40 | 33 |
| | | ii | 30 | 40 | 60 | — | — |
| HDPE | Modified | i | 70 | 60 | 40 | — | 10 |
| | | ii | — | — | — | 60 | — |

| | | | | | |
|---|---|---|---|---|---|
| Unmodified | — | — | — | — | 57 |

| Kneading temperature | | 80 | 80 | 80 | 210 | 210 |
|---|---|---|---|---|---|---|
| (° C.) | | | | | | |
| Maximum tensile | | 33.0 | 36.9 | 48.4 | 31.1 | 36.7 |
| strength (MPa) | | | | | | |
| Flexural modulus (MPa) | | 1200 | 1250 | 1800 | 1340 | 1400 |
| Dispersibility | Sea | EVOH | EVOH | EVOH | HDPE | HDPE |
| | phase | | | | | |
| | Island | HDPE | HDPE | HDPE | EVOH | EVOH |
| | phase | | | | | |

Next, hoses were produced by using the above materials.

### EXAMPLES 1 to 12 AND COMPARATIVE EXAMPLES 1 to 6

Each material for forming an inner layer, a low-permeability layer, a bonding layer and an outer layer was prepared. Then, each material was melt-extruded (co-extruded) from each extruder and was combined into one die, and then is passed through a sizing die, whereby a hose (inner diameter: 8 mm, outer diameter: 10 mm) comprising the inner layer, the low-permeability layer, the bonding layer, and the outer layer formed in this order was produced. Where there is no data in the following Tables 3 and 4, such a layer was not formed. Also, the thickness of each layer is as shown in the Tables 3 and 4.

TABLE 3

| | EXAMPLE | | | | | | | | |
|---|---|---|---|---|---|---|---|---|---|
| | 1 | 2 | 3 | 4 | 5 | 6 | 7 | 8 | 9 |
| Inner layer | — | Modified | Alloy | — | — | Modified | Modified | Modified | Modified |
| | | HDPE (i) | material d | | | HDPE (i) | HDPE (i) | HDPE (i) | HDPE (i) |
| Thickness | — | 0.1 mm | 0.1 mm | — | — | 0.1 mm | 0.1 mm | 0.1 mm | 0.1 mm |
| Low permeability | Alloy | Alloy | Alloy | Alloy | Alloy | Alloy | Alloy | Alloy | Alloy |
| layer | material a | material a | material a | material a | material a | material a | material b | material b | material b |
| Thickness | 0.2 mm | 0.2 mm | 0.2 mm | 0.2 mm | 0.2 mm | 0.2 mm | 0.2 mm | 0.1 mm | 0.3 mm |
| Bonding layer | — | — | — | Modified | Alloy | Modified | Modified | Modified | Modified |
| | | | | HDPE (i) | material d | HDPE (i) | HDPE (i) | HDPE (i) | HDPE (i) |
| Thickness | — | — | — | 0.1 mm | 0.1 mm | 0.1 mm | 0.1 mm | 0.1 mm | 0.1 mm |
| Outer layer | PA12 (i) | PA12 (i) | PA12 (i) | PA12 (ii) | PA12 (i) | PA12 (ii) | PA12 (ii) | PA12 (ii) | PA12 (ii) |
| Thickness | 0.8 mm | 0.7 mm | 0.7 mm | 0.7 mm | 0.7 mm | 0.6 mm | 0.6 mm | 0.7 mm | 0.5 mm |

TABLE 4

| | EXAMPLE | | | COMPARATIVE EXAMPLE | | | | | |
|---|---|---|---|---|---|---|---|---|---|
| | 10 | 11 | 12 | 1 | 2 | 3 | 4 | 5 | 6 |
| Inner layer | Modified | Modified | Alloy | — | Modified | Modified | — | — | Alloy |
| | HDPE (i) | HDPE (i) | material d | | HDPE (i) | HDPE (i) | | | material d |
| Thickness | 0.1 mm | 0.1 mm | 0.1 mm | — | 0.1 mm | 0.1 mm | — | — | 0.1 mm |
| Low permeability | Alloy | Alloy | Alloy | Alloy | Alloy | EVOH (i) | EVOH (i) | Alloy | Alloy |
| layer | material c | material b | material b | material a | material d | | | material a | material e |
| Thickness | 0.2 mm | 0.2 mm | 0.2 mm | 0.2 mm | 0.2 mm | 0.2 mm | 0.2 mm | 0.2 mm | 0.2 mm |
| Bonding layer | Modified | Alloy | Modified | — | — | — | Modified | Alloy | Alloy |
| | HDPE (i) | material d | HDPE (i) | | | | HDPE (i) | material d | material d |
| Thickness | 0.1 mm | 0.1 mm | 0.1 mm | — | — | — | 0.1 mm | 0.1 mm | 0.1 mm |
| Outer layer | PA12 (ii) | PA12 (i) | PA12 (ii) | PA12 (ii) | PA12 (ii) | PA12 (ii) | PA12 (ii) | PA12 (ii) | PA12 (i) |
| Thickness | 0.6 mm | 0.6 mm | 0.6 mm | 0.8 mm | 0.7 mm | 0.7 mm | 0.7 mm | 0.7 mm | 0.6 mm |

The low-permeability resin hoses of Examples and Comparative Examples thus produced were evaluated for characteristic properties thereof in the following manner. The results are shown in Tables 5 to 7.

### Permeability to Gasoline

Each hose was filled with a model gasoline containing alcohol prepared by blending toluene/isooctane/ethanol at 45:45:10 (by volume). Then, permeability to gasoline (at mg/m/day) of the hose was determined by means of isobaric permeability measuring equipment of hose (GTR-TUBE3-TG available from GTR TEC CORP) at 40° C. for one month. In Tables 5 to 7, each value represents a value when equilibrium is achieved. In the same tables, the notation “<0.1” indicates that the measured fuel permeation was below the measurement limitation (0.1 mg/m/day) of the aforesaid measurement method.

### Interlaminar Adhesion

A specimen having a width of 10 mm was cut out of each of the hoses. Each interface was peeled at a distal end, and each distal end was pinched by a chuck of a tensile tester, and pulled at a rate of 50 mm/min for the evaluation of peeling strength (N/cm) at 180 degrees. In Tables 5 to 7, a symbol ◯ indicates that the hose was broken because of no interfacial separation, which means excellent interlaminar adhesion. It is thought that peeling strength of not less than 20 N/cm has good interlaminar adhesion.

### Solvent Cracking

An assembly portion (having a diameter of 10 mm) of a QC connector was pressed into a distal end of each hose, and a model gasoline containing alcohol used for evaluation of the permeability to gasoline was filled into the hose, and then allowed to stand at 60° C. for 500 hours. Thereafter, the hose was withdrawn from the assembly portion, status of the distal end of the hose was observed. No cracking on the distal end of the hose was evaluated as ◯ (good), while cracking identified thereon was evaluated as X (poor).

TABLE 5

| | | EXAMPLE | | | | | | |
|---|---|---|---|---|---|---|---|---|
| | | 1 | 2 | 3 | 4 | 5 | 6 | 7 |
| Permeability to gasoline* | | <0.1 | <0.1 | <0.1 | <0.1 | <0.1 | <0.1 | <0.1 |
| Interlaminar | inner layer/ | — | ◯ | ◯ | — | 13 | ◯ | ◯ |
| adhesion | low-permeability layer | | | | | | | |
| (N/cm) | | | | | | | | |
| | low permeability | 54 | 54 | 53 | ◯ | 22 | ◯ | ◯ |
| | layer/bonding layer bonding | | | | ◯ | 42 | ◯ | ◯ |
| | layer/outer layer | | | | | | | |

| | | | | | | | |
|---|---|---|---|---|---|---|---|
| Solvent cracking | ◯ | ◯ | ◯ | ◯ | ◯ | ◯ | ◯ |

*permeation amount of gasoline (mg/m/day)

TABLE 6

| | | EXAMPLE | | | | |
|---|---|---|---|---|---|---|
| | | 8 | 9 | 10 | 11 | 12 |
| Permeability to gasoline* | | <0.1 | <0.1 | <0.1 | <0.1 | <0.1 |
| Interlaminar | inner layer/ | ◯ | ◯ | ◯ | ◯ | ◯ |
| adhesion (N/cm) | low-permeability | | | | | |
| | layer | | | | | |
| | low permeability | ◯ | ◯ | ◯ | 23 | 25 |
| | layer/bonding | | | | | |
| | layer | | | | | |
| | bonding | ◯ | ◯ | ◯ | 44 | ◯ |
| | layer/outer layer | | | | | |

| | | | | | |
|---|---|---|---|---|---|
| Solvent cracking | ◯ | ◯ | ◯ | ◯ | ◯ |

*permeation amount of gasoline (mg/m/day)

TABLE 7

| | | COMPARATIVE EXAMPLE | | | | | |
|---|---|---|---|---|---|---|---|
| | | 1 | 2 | 3 | 4 | 5 | 6 |
| Permeability to gasoline* | | — | 98 | — | — | — | 4.0 |
| Interlaminar | inner layer/ | — | ◯ | 15 | — | — | ◯ |
| adhesion | low-permeability | | | | | | |
| (N/cm) | layer | | | | | | |
| | low permeability | 2 | 23 | 14 | 16 | 22 | ◯ |
| | layer/bonding | | | | | | |
| | layer | | | | | | |
| | bonding | | | | ◯ | 5 | 40 |
| | layer/outer layer | | | | | | |

| | | | | | | |
|---|---|---|---|---|---|---|
| Solvent cracking | — | ◯ | X | X | — | ◯ |

*permeation amount of gasoline (mg/m/day)

As can be understood from the results shown in the Tables, the hoses of the Examples were less permeable to gasoline, and were excellent in interlaminar adhesion, and also no cracking occurred.

On the other hand, each hose of Comparative Examples 1 and 5 was inferior in interlaminar adhesion with the outer layer comprising polyamide having a low amino value. Permeation amount of gasoline of each hose of Comparative Examples 2 and 6 was great because the low-permeability layer comprising the specific alloy material was not provided. Since each hose of Comparative Examples 3 and 4 was provided with an EVOH layer as a low-permeability layer, solvent cracking occurred.

As for low-permeability resin hoses of Examples 1, 2 and 7, an assembly portion (diameter: 10 mm) of a QC connector was pressed into a distal end of each hose, and an U-shape jig heated to 200° C. was uniformly applied to an outer periphery of the assembly portion for welding. The material of the QC connector is a mixture of PA12 (i) as above and 30% by weight of glass fiber (GF). Each permeability to gasoline on the welded portion determined by means of isobaric permeability measuring equipment of hose (GTR-TUBE3-TG available from GTR TEC CORP) of Examples 1, 2 and 7 was 0.1 mg/day, which was remarkably less than value (1 mg/day) in the case where the low-permeability resin hoses of Examples 2 and 7 were not welded.

The low-permeability resin hose of the present invention is preferably applicable to an automotive fuel transportation hose such as a gasoline fuel hose, a refrigerant transportation hose for air-conditioner used in vehicles such as automobiles, a radiator hose for connecting an engine and a radiator, an engine-cooling hose such as a heater hose for connecting an engine and a heater core, fuel cell hoses such as a methanol fuel hose and a hydrogen fuel hose.

What is claimed is:

1. A low-permeability resin hose comprising: a tubular low-permeability layer formed by using the following component (A); and an outer layer formed by using the following component (B) on an outer peripheral surface of the low-permeability layer:
(A) an alloy material wherein an island phase (domain) comprising modified high-density polyethylene resin is dispersed in a sea phase (matrix) comprising an ethylene-vinyl alcohol copolymer;
(B) polyamide resin having a high amino value.

2. A low-permeability resin hose as set forth in claim 1, wherein an inner layer is formed by using an alloy material wherein an island phase (domain) comprising an ethylene-vinyl alcohol copolymer is dispersed in a sea phase (matrix) comprising modified high-density polyethylene resin, or modified high-density polyethylene resin on an inner peripheral surface of the low-permeability layer.

3. A low-permeability resin hose as set forth in claim 1, wherein a bonding layer is formed by using an alloy material wherein an island phase (domain) comprising an ethylene-vinyl alcohol copolymer is dispersed in a sea phase (matrix) comprising modified high-density polyethylene resin, or modified high-density polyethylene resin between the low-permeability layer and the outer layer.

4. A low-permeability resin hose as set forth in claim 2, wherein a bonding layer is formed by using an alloy material wherein an island phase (domain) comprising an ethylene-vinyl alcohol copolymer is dispersed in a sea phase (matrix) comprising modified high-density polyethylene resin, or modified high-density polyethylene resin between the low-permeability layer and the outer layer.

5. A low-permeability resin hose as set forth in claim 1, wherein the polyamide resin having a high amino value (component (B)) has amino terminal group concentration of not less than 40μ equivalent weight/g.

6. A low-permeability resin hose as set forth in claim 2, wherein the polyamide resin having a high amino value (component (B)) has amino terminal group concentration of not less than 40μ equivalent weight/g.

7. A low-permeability resin hose as set forth in claim 3, wherein the polyamide resin having a high amino value (component (B)) has amino terminal group concentration of not less than 40μ equivalent weight/g.

8. A low-permeability resin hose as set forth in claim 4, wherein the polyamide resin having a high amino value (component (B)) has amino terminal group concentration of not less than 40μ equivalent weight/g.

9. A low-permeability resin hose comprising: a tubular low-permeability layer formed by using the following component (A); a bonding layer formed by using the following component (C) on an outer peripheral surface of the low-permeability layer; and an outer layer formed by using the following component (D) on an outer peripheral surface of the bonding layer:
(A) an alloy material wherein an island phase (domain) comprising modified high-density polyethylene resin is dispersed in a sea phase (matrix) comprising an ethylene-vinyl alcohol copolymer;
(C) modified high-density polyethylene resin;
(D) polyamide resin having a low amino value.

10. A low-permeability resin hose as set forth in claim 9, wherein an inner layer is formed by using an alloy material wherein an island phase (domain) comprising an ethylene-vinyl alcohol copolymer is dispersed in a sea phase (matrix) comprising modified high-density polyethylene resin, or modified high-density polyethylene resin on an inner peripheral surface of the low-permeability layer.

11. A low-permeability resin hose as set forth in claim 1, wherein the low-permeability resin hose is an automotive fuel transportation hose or a refrigerant transportation hose.

12. A low-permeability resin hose as set forth in claim 2, wherein the low-permeability resin hose is an automotive fuel transportation hose or a refrigerant transportation hose.

13. A low-permeability resin hose as set forth in claim 3, wherein the low-permeability resin hose is an automotive fuel transportation hose or a refrigerant transportation hose.

14. A low-permeability resin hose as set forth in claim 4, wherein the low-permeability resin hose is an automotive fuel transportation hose or a refrigerant transportation hose.

15. A low-permeability resin hose as set forth in claim 5, wherein the low-permeability resin hose is an automotive fuel transportation hose or a refrigerant transportation hose.

16. A low-permeability resin hose as set forth in claim 6, wherein the low-permeability resin hose is an automotive fuel transportation hose or a refrigerant transportation hose.

17. A low-permeability resin hose as set forth in claim 7, wherein the low-permeability resin hose is an automotive fuel transportation hose or a refrigerant transportation hose.

18. A low-permeability resin hose as set forth in claim 8, wherein the low-permeability resin hose is an automotive fuel transportation hose or a refrigerant transportation hose.

19. A low-permeability resin hose as set forth in claim 9, wherein the low-permeability resin hose is an automotive fuel transportation hose or a refrigerant transportation hose.

20. A low-permeability resin hose as set forth in claim 10, wherein the low-permeability resin hose is an automotive fuel transportation hose or a refrigerant transportation hose.
